(19) United States
(12) Patent Application Publication
(10) Pub. No.: US 2025/0004280 A1
(43) Pub. Date: Jan. 2, 2025

(54) VIRTUAL OBJECT VISIBILITY IMPROVEMENT WEARABLE DISPLAY DEVICE

(71) Applicant: GEEKS LOFT INC., Seongnam-si (KR)

(72) Inventor: Scott Seongwook LEE, Suwon-si (KR)

(73) Assignee: GEEKS LOFT INC., Seongnam-si (KR)

(21) Appl. No.: 18/884,131

(22) Filed: Sep. 13, 2024

Related U.S. Application Data
(63) Continuation of application No. PCT/KR2023/010625, filed on Jul. 21, 2023.

(30) Foreign Application Priority Data
Jul. 21, 2022 (KR) 10-2022-0090474

(51) Int. Cl. G02B 27/01; G09G 3/00

(52) U.S. Cl. CPC G02B 27/0172; G09G 3/001; G02B 2027/0118; G09G 2340/045

(57) ABSTRACT

The virtual object visibility improvement device includes an auxiliary transparent display unit that displays a shaded area matching the size of the virtual object behind the transparent display unit that displays the virtual object, and when viewed by the human eye, the virtual object is displayed on the real space actual object in the transparent display unit, and the light of the real space actual object is not transmitted to the virtual object due to the shaded area, so that the virtual object is not visible to be overlapped with the real space actual object.

### CROSS-REFERENCE TO RELATED APPLICATIONS

This application is a bypass continuation of International Application No. PCT/KR2023/010625, filed on Jul. 21, 2023, which is based on and claims priority to Korean Patent Application No. 10-2022-0090474, filed on Jul. 21, 2022, in the Korean Intellectual Property Office, the disclosures of which are incorporated by reference herein in their entireties.

### BACKGROUND

### 1. Field

The present invention relates to a wearable display device, and more particularly, to a wearable display device that provides augmented reality or a virtual object visibility improvement device.

### 2. Description of Related Art

Global IT industry, such as Google, Facebook, Microsoft, and Samsung, does not save a large-scale investment in virtual reality (VR), augmented reality (AR), and mixed reality (MR).

These techniques are in line with attempts to expand and amplify the sensation of reality beyond space-time. Therefore, these techniques are collectively referred to as Extend Reality (XR). The xr technology can deviate from the constraints of reality through convergence with various fields as well as games and allow consumers to experience new experiences.

The virtual reality technology refers to a technology that makes the virtual space that is not present in the real world by using a computer and then feel the virtual space like reality, and the augmented reality or mixed reality technology refers to a technology that expresses information generated by the computer on the real world, that is, a technology that combines the real world and the virtual world to interact with the user in real time.

The XR headset to which the XR technology is applied is equipped with a transparent display device that combines the real world and the virtual world and outputs them in real time.

However, the transparent display device has a transparent property and represents a device that displays the backside background as it is.

FIG. 1 is a diagram illustrating a perspective of outputting a virtual object and a background image on a transparent display device according to the prior art.

The transparent display device outputs the virtual object, but has inevitably overlap with the background image due to the characteristics of the transparent display device, and accordingly, the visibility and realistic sense of the virtual object are degraded. These problems have become a large factor that hinders the activation or popularization of the XR technology.

Meanwhile, virtual reality, augmented reality, and mixed reality technology that have been applied to computer graphics technology have recently developed. In this case, the virtual reality technology refers to a technology that makes the virtual space that is not present in the real world by using a computer and then feel the virtual space like reality, and the augmented reality or mixed reality technology refers to a technology that expresses information generated by the computer on the real world, that is, a technology that combines the real world and the virtual world to interact with the user in real time.

Among them, the augmented reality and mixed reality technology have been used by grafting with technologies (e.g., broadcasting technology, medical technology, and gaming technology, and the like) in various fields. A representative example of the augmented reality technology is grafted into the broadcasting technology field when the weather casters that have naturally changed weather maps in front of the weather casters that makes fore weather casters from tv, or inserting advertisement images that do not exist in the stadium in sports relaying are used by sending on the screen as if the stadium is actually exist in the stadium.

### SUMMARY

In order to solve such a problem, the present invention provides a virtual object visibility improvement device that includes an auxiliary transparent display unit that displays a shaded area matching the size of the virtual object behind a transparent display unit that displays the virtual object, wherein the virtual object is displayed on the real space actual object in the transparent display unit when viewed by the human eye, and the light of the real space actual object is not transmitted to the virtual object due to the shaded area, so that the virtual object does not overlap the real space actual object.

In addition, the present invention provides a wearable display device that can be easily worn by a user. An embodiment of the present invention provides a wearable display device that can output images and sounds simultaneously to provide augmented reality.

An embodiment of the present invention provides a wearable display device that can easily adjust the length and focus according to a user's body.

A device for improving virtual object visibility according to aspects of the present invention to achieve the above objects includes,

A transparent display unit that displays a virtual object representing a graphic object;

An auxiliary transparent display unit that is positioned behind the transparent display unit, generates a shaded area matching the size of the virtual object, and displays the generated shaded area at the same position as the virtual object, so that light of a real-world actual object that appears as a background through the transparent display unit does not penetrate the virtual object; and

Control unit that controls the shaded area to be output to the auxiliary transparent display unit at the same position as the virtual object when the virtual object is displayed on the transparent display unit, and when viewed with the human eye, the transparent display unit can display the virtual object on the real space actual object, and the virtual object can prevent the light of the real space actual object from being transmitted to the virtual object due to the shaded area, so that the virtual object does not overlap the real space actual object. According to an embodiment of the present invention, a virtual object visibility improvement device includes a transparent display unit that displays a virtual object on an image of a actual object in a real space; and an auxiliary transparent display unit that generates a shaded area corresponding to the virtual object at the back of the virtual object, so that the image of the actual object does not penetrate the virtual object due to the shaded area, so that the virtual object does not overlap the real-world actual object.

The transparent display unit and the auxiliary transparent display unit may form a structure protruding toward a user on the same glass band.

The transparent display unit and the auxiliary transparent display unit may be separately formed to distinguish between left and right eyes.

The transparent display unit and the auxiliary transparent display unit may form a structure stacked on the glass band.

The virtual object visibility improvement device may further include a control unit that controls the shaded area to be output to the auxiliary transparent display unit when the virtual object is displayed on the transparent display unit.

The control unit may separate foreground pixels and background pixels from virtual objects to perform binarization processing, generate outlines from binarized virtual objects, calculate the size and position of the shaded area, and adjust each pixel value of the calculated shaded area to perform shading.

The control unit may determine foreground pixels and background pixels by converting the input image into a predetermined size, calculating covariance of color values (r, g, b) of each pixel, and separating them into k Gaussian distributions.

The control unit may perform a scale adjustment operation by matching the entire pixel position and size of the transparent display unit and the auxiliary transparent display unit, calculate the position and pixel size of the virtual object information in the transparent display unit, and calculate the position and pixel size of the shaded area in the auxiliary transparent display unit based on the calculated position and pixel size of the virtual object information.

The control unit may synchronize the display of the virtual object on the transparent display unit and the display of the shaded area on the auxiliary transparent display unit to simultaneously output the display of the virtual object.

The control unit may convert the camera image data to have the same position coordinate and pixel size as the output image data and adjust the image size so that the camera image data and the output image data have the same size.

According to an embodiment of the present invention, a wearable display device wearable on a user's head and provides augmented reality, the wearable display device includes: a seating frame seated on the user's head; a rotating frame rotatably coupled to the seating frame; an image output unit fixed to the rotating frame and transmitting light of an external environment and outputting an image; and an acoustic output unit fixed to one end of the seating frame and covering the user's ears and outputting sound, wherein the image output unit may be selectively disposed in front of the user's eyes as the image output unit is rotated together with the rotating frame.

The rotating frame may include: a rotating frame body forming the shape of the rotating frame and fixing the image output unit; and a length adjusting unit configured to connect the rotating frame body and the seating frame and adjust a distance between the image output unit and the user's eyes.

The length adjusting unit may include: a boss rotatably coupled to the seating frame; a band extending in one direction from the boss and forming a plurality of grooves on one surface; an insertion groove formed in one end of the rotating frame body so that the band is inserted; and an elastic protrusion protruding from an inner surface of the insertion groove, inserting one end into one of the plurality of grooves and elastically deforming the insertion groove in a direction in which the one end is removed when a force of a predetermined intensity or more is applied via the band.

The seating frame may include a seating groove having one end close contact with the rotating frame so that the rotating frame rotates rearward and preventing the rotating frame overlapping with the seating frame from unintentionally rotating forward.

The rotating frame may further include a shield located in front of the image output unit and guiding the shield to the image output unit by transmitting light of an external environment.

According to the above-described configuration, when the virtual object is displayed on the real space actual object, the present invention prevents the light of the real space actual object from being transmitted to the corresponding virtual object, thereby improving the visibility of the virtual object, thereby improving the realism of the virtual object being considered as an object existing in the real space.

In addition, according to an embodiment, the wearable display device may provide an image to the user by overlaying the image on the external environment landscape through a transparent display and provide sound to the user through a speaker, thereby realizing a living sense of augmented reality.

In addition, according to an embodiment, the user may intuitively and easily adjust the focus by adjusting the distance between the image output unit and its eyes using the first length adjusting unit of the wearable display device.

According to an embodiment, the rotating frame in the folded state may be prevented from being rotated in an unfolded state by using the frictional force between the seating protrusion and the seating groove.

### BRIEF DESCRIPTION OF THE DRAWINGS

FIG. 1 is a diagram illustrating a state in which a virtual object and a background image are output to a transparent display device according to the conventional technology.

FIG. 2 is a diagram illustrating a configuration of a virtual object visibility improvement device according to an embodiment of the present invention.

FIG. 3 is a diagram illustrating a state in which the visibility and realism of a images played using a transparent display unit and an auxiliary transparent display unit according to an embodiment of the present invention are improved. FIG. 4 is a diagram schematically illustrating an internal configuration of a wearable display device according to an embodiment of the present invention.

FIG. 5 is a diagram illustrating a folding state of a wearable display device according to an embodiment of the present invention.

FIGS. 6 to 7 are diagrams illustrating an unfolding state of the wearable display device shown in FIG. 5.

FIG. 8 is a diagram enlarged a portion of the wearable display device shown in FIG. 7.

FIG. 9 is a schematic diagram illustrating a process in which a portion of the wearable display device shown in FIG. 5 is moved from an unfolding state to a folding state.

FIG. 10 is a diagram illustrating a length adjusting unit of the wearable display device shown in FIG. 5.

FIG. 11 is a diagram illustrating a folding state of a wearable display device according to an embodiment.

FIG. 12 is a diagram illustrating the unfolding state of the wearable display device illustrated in FIG. 11.

FIG. 13 is a diagram illustrating the unfolding state of the wearable display device illustrated in FIG. 11.

FIG. 14 is an enlarged view of a portion of the wearable display device illustrated in FIG. 11.

FIG. 15 is a schematic diagram illustrating a process of moving a part of the wearable display device illustrated in FIG. 11 from an unfolded state to a folded state.

FIG. 16 is a diagram illustrating the length adjusting part of the wearable display device illustrated in FIG. 11.

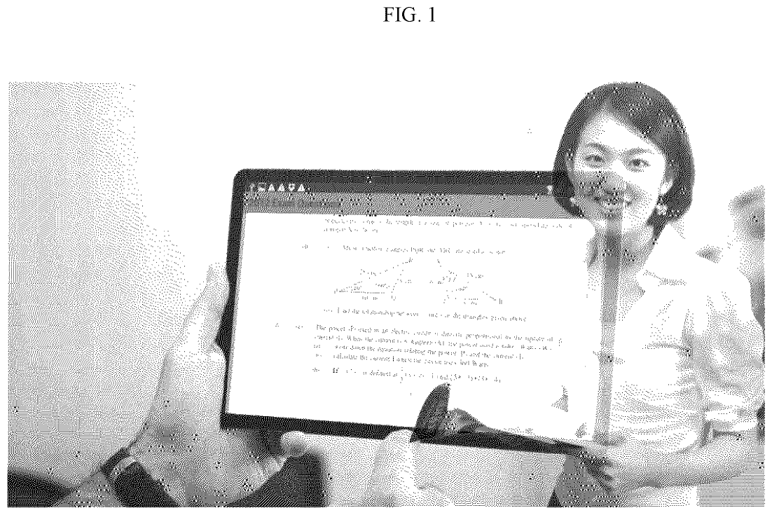

### DETAILED DESCRIPTION

The present invention may be variously modified and have various embodiments, and specific embodiments are illustrated in the drawings and will be described in detail in the detailed description. However, this is not intended to limit the present invention to specific embodiments, and it should be understood that all changes, equivalents, or alternatives included in the spirit and scope of the present invention are included. In describing each figure, similar reference numerals were used for similar components.

The terms first, second, a, b, etc., may be used to describe various elements, but these elements should not be limited by these terms. The terms are used only for the purpose of distinguishing one element from another. For example, the first component may be named a second component without departing from the scope of the present invention, and similarly, the second component may be named the first component. The term “and/or” includes any combination of a plurality of associated listed items or any of a plurality of associated listed items.

It should be understood that when an element is referred to as being “connected” or “connected” to another element, it may be directly connected or connected to the other element, but other elements may be present in the middle. On the other hand, when an element is referred to as being “directly connected” or “directly connected” to another element, it should be understood that there are no other elements in the middle.

The terminology used in this application is used merely to describe specific embodiments, and is not intended to limit the present invention. The expression of a singular includes multiple expressions unless the context clearly means otherwise. In the present application, the term “include” or “have” should be understood to designate the presence of features, numbers, steps, operations, components, parts or combinations thereof described in the specification, but not exclude the presence or addition of one or more other features, numbers, steps, operations, components, parts or combinations thereof.

Unless defined otherwise, all terms used herein, including technical or scientific terms, have the same meaning as commonly understood by one of ordinary skill in the art to which this invention belongs. Terms such as those defined in commonly used dictionaries should be interpreted as having a meaning that is consistent with their meaning in the context of the relevant art and are not interpreted in an idealized or overly formal sense unless expressly so defined herein.

Hereinafter, preferred embodiments of the present invention will be described in more detail with reference to the accompanying drawings. In the description of the present invention, the same reference numerals are used for the same components in the drawings to facilitate the overall understanding, and duplicate descriptions of the same components will be omitted.

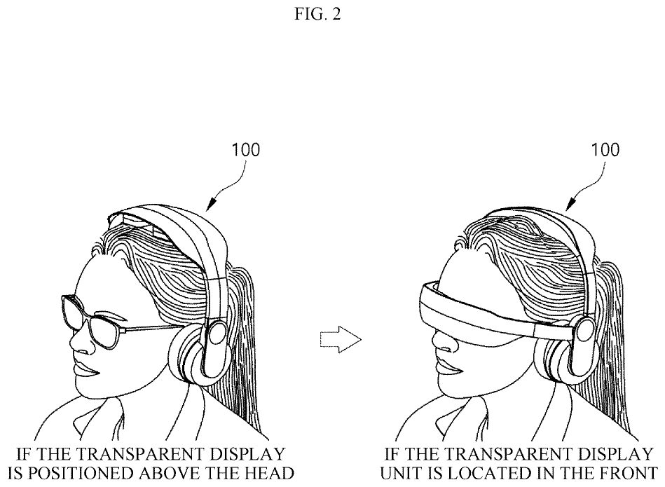

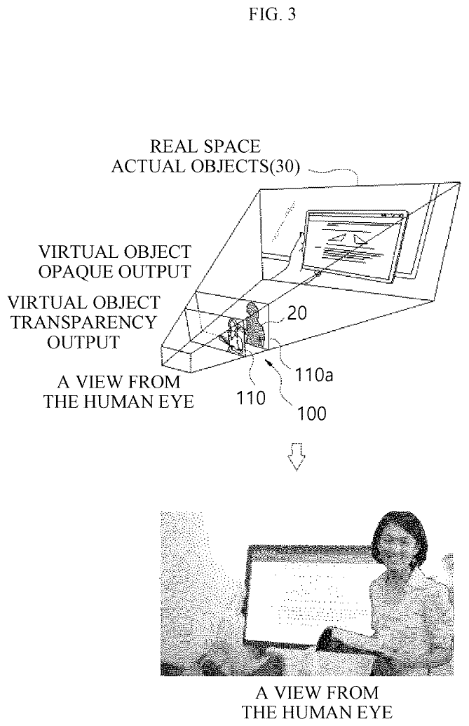

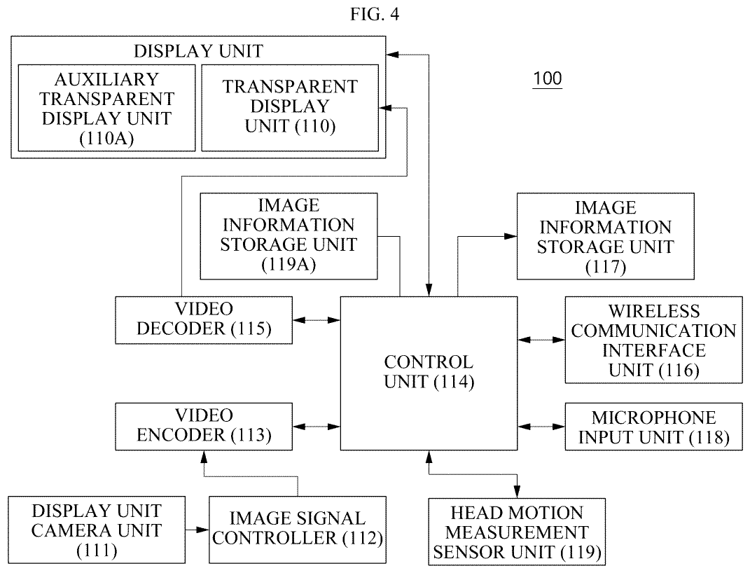

FIG. 2 is a diagram illustrating the configuration of the virtual object visibility improvement device according to an embodiment of the present invention, FIG. 3 is a diagram illustrating a state in which the visibility and realism of images played using a transparent display unit and an auxiliary transparent display unit according to an embodiment of the present invention are improved, and FIG. 4 is a diagram schematically illustrating the internal configuration of the wearable display device according to an embodiment of the present invention.

The virtual object visibility improvement device according to an embodiment of the present invention includes a wearable display device 100 consisting of a transparent display unit 110, an auxiliary transparent display unit 110a, a camera unit 111, a image signal controller 112, a video encoder 113, a control unit 114, a video decoder 115, a wireless communication interface unit 116, an audio output unit 117, a microphone input unit 118, a head motion measurement sensor unit 119, and a image information storage unit 119a.

The virtual object visibility improvement device includes a wearable display device 100 seated on the head of a user, which disposes the transparent display unit 110 located in front of the eye of the person to output the virtual object, and disposes an additional auxiliary transparent display unit 110a between the transparent display unit 110 and the real space actual object 30 visible by the eye of the person through the transparent display unit 110.

The wearable display device 100 sequentially disposes the transparent display unit 110 and the auxiliary transparent display unit 110a such that the transparent display unit 110 is located closer to the eye of the person than the auxiliary transparent display unit 110a from the eye of the person.

When the virtual object is displayed on the transparent display unit 110, the wearable display device 100 outputs a shaded region 20 to the auxiliary transparent display unit 110a at the same size and position as the virtual object. Therefore, the wearable display device 100 blocks the light of the real space actual object 30, which is the background of the virtual object visible through the transparent display unit 110, so that the virtual object is not visible to overlap with the real space actual object 30, thereby improving the visibility and realistic sense.

The wearable display device 100 includes a diffusion reality computing device (not shown) configured with a data input unit and a data output unit, and wirelessly connected to the wearable display device 100 through a communication network to calculate expansion reality content and applications.

The wearable display device 100 may be an XR headset, and wirelessly separate the structure of the transparent display unit 110 additionally configured with the auxiliary transparent display unit 110a and the augmented reality computing device of the wearable display device 100 and the data output unit and the diffusion reality computing device of the data computation unit, and transmit and receive high-quality image information and voice information through bidirectional wireless communication.

An augmented reality computing device (not shown) may include, for example, a PC, a notebook, a tablet, a smartphone, and the like.

The control unit 114 generates a virtual object and outputs to the transparent display unit 110, and generates a shaded area 20 having the same size as the virtual object. It is assumed that the same size and coordinate area are the same as the transparent display unit 110 and the auxiliary transparent display unit 110a.

The control unit 114 calculates coordinates displayed on the transparent display unit 110, and outputs the shaded area 20 in real time.

In other words, the shaded region 20 is located behind the virtual object so that light of the real space actual object 30 visible as a background through the transparent display unit 110 cannot be transmitted to the virtual object.

The virtual object projected on the transparent display unit 110 may be image data pre-stored in the image information storage 119a, camera image data captured by the camera unit 111, or an object created through a three-dimensional model of the virtual space under the control of the control unit 114.

As shown in FIG. 3, the present invention projects and shows the virtual object output to the transparent display unit 110 and the shaded region 20 output to the auxiliary transparent display unit 110a together to the real space actual object 30 when the real space actual object 30 is externally seen through the transparent display unit 110 by the human eye.

The shaded region 20 formed in the auxiliary transparent display unit 110a is calculated and generated in real time at the same time as the generation of the virtual object under the control of the control unit 114.

The camera unit 111 is composed of a right camera and a left camera to acquire one-directional images captured by two camera lenses. Two camera lenses are arranged in one direction, and two one-way images captured by an area corresponding to the angle of view that can be captured at the position where each camera is arranged can be acquired. The camera unit 111 may be arranged at a position close to the user's eye.

The image signal controller 112 generates bitstream data including video data and signal data for the image received from the camera unit 111.

The video encoder 113 encodes the bitstream data received from the image signal controller 112 and outputs the encoded image data.

The control unit 114 is connected to the video decoder 115 and transmits and stores encoded image data received from the video encoder 113 to the image information storage unit 119a. The image information storage 119a may be camera image data (virtual object) captured by the camera unit 111 or not the image data captured by the camera unit 111, but may be image data (virtual object) pre-stored during the device design.

The image information storage 119a may store image data (virtual object) created through a three-dimensional model of the virtual space under the control of the control unit 114.

The control unit 114 may edit the camera image data captured by the camera unit 111 to generate a virtual object, and store the generated virtual object in the image information storage 119a.

Here, the virtual object may be an image, a text, a content playback screen, an application execution screen, a web browser screen, various graphic objects, etc.

The video decoder 115 decodes the image data, which is analog data stored in the image information storage 119a, to generate uncompressed output image data, which is digital data, and outputs the generated uncompressed output image data to the transparent display unit 110 so as to be projected to the transparent display unit 110.

The display sequentially arranges the transparent display unit 110 and the auxiliary transparent display unit 110a.

The transparent display unit 110 displays output image data including a virtual object representing a graphic object under the control of the control unit 114.

The control unit 114 outputs the virtual object to the auxiliary transparent display unit 110a in a state that the real space actual object 30 located at the background is transparently visible, and simultaneously outputs the shaded region 20 in real time.

Here, the background refers to the opposite side of the human eye based on the transparent display unit 110, and may be an external environment projected through the transparent display 110 unit and the auxiliary transparent display unit 110a.

The control unit 114 generates the shaded region 20 by shadowing the same size of the virtual object to be displayed on the transparent display unit 110.

The control unit 114 displays one or more shaded regions 20 on the auxiliary transparent display unit 110a so that the light of the background (real space actual object 30) is not transmitted.

When there are a plurality of virtual objects, the control unit 114 forms the same number of shaded regions 20 that match the size of the virtual object as the same as the number of virtual objects, and calculates coordinates that the virtual object will be displayed on the transparent display unit 110.

The control unit 114 outputs each shaded region 20 to the auxiliary transparent display unit 110a using the calculated coordinates.

The control unit 114 synchronizes and simultaneously outputs the display of the virtual object on the transparent display unit 110 and the display of the shaded region 20 on the auxiliary transparent display unit 110a.

In another embodiment, the control unit 114 may sequentially display the display of the virtual object on the transparent display unit 110 and the display of the shaded region 20 on the auxiliary transparent display unit 110a with a time difference.

As shown in FIG. 3, from the perspective of the human eye, the virtual object is displayed on the real space actual object 30 on the transparent display unit 110, and the virtual object is not transmitted to the virtual object due to the shaded region 20, so that the virtual object is not visible to be overlapped with the real space actual object 30, and the virtual object is displayed on the transparent display unit 110.

Hereinafter, a method of generating the shaded region 20 will be described in detail.

The control unit 114 separates the foreground pixel and the background pixel for the virtual object from the image data to perform binarization processing, generates the contour from the binarized virtual object, extracts the pixels included in the contour to calculate the size and position of the shaded region 20.

After separating the foreground pixel and the background pixel, the algorithm for extracting the object shape performs a processing process of converting the input image frame to a predetermined size (e.g., 640×480), comparing the pixels of the previous frame data and the current frame pixel data to determine the foreground pixel or the background pixel, and separating the foreground pixel to extract the object shape.

That is, the control unit 114 converts the input image to the predetermined size, calculates the covariance of the color values (r, g, b) of each pixel, and determines the foreground pixel and the background pixel after separating them into k Gaussian distributions. Then, the control unit 114 extracts the contour from the binarized image separated into the foreground pixel and the background pixel to extract the object shape. The algorithm for extracting the object shape may be various methods and may be known in the art.

The control unit 114 adjusts the calculated pixel values of the shaded region 20 to perform shading processing, and outputs the shaded shaded region 20 to the auxiliary transparent display unit 110a.

In another embodiment, the control unit 114 may set the shaded region 20 of the auxiliary transparent display unit 110a to various colors such as black and gray if the light of the real space actual object 30 is not transmitted to the virtual object.

The control unit 114 may determine the color of the shaded region 20 according to the color of the virtual object. Here, any color of the shaded region 20 may be available if the light of the real space actual object 30 is not transmitted.

In another embodiment, the control unit 114 may perform a scale adjustment operation by matching the entire pixel position and size of the transparent display unit 110 and the auxiliary transparent display unit 110 a, calculate the position and pixel size of the virtual object information in the transparent display unit 110, and calculate the position and pixel size of the shadow region 20 in the auxiliary transparent display unit 110 a based on the calculated position and pixel size of the virtual object information.

The control unit 114 generates a contour from the binarized virtual object, extracts first pixels belonging to the inside of the contour, and second pixels as much as the predetermined margin pixel size from the contour to the outside, adjusts each pixel value of the first pixels and the second pixels to generate a shaded region 20 by performing shadowing processing, and outputs the generated shaded region 20 to the auxiliary transparent display unit 110a.

Here, the margin pixel size represents pixels located along the contour by a predetermined reference pixel (e.g., 2 to 3 pixels).

The present invention may form the shaded region 20 larger than the virtual object to prevent the possibility of light transmitted by the real space actual object 30 from being transmitted.

The audio output unit 117 outputs the audio signal received from the diffuse reality calculation device to the outside. The microphone input unit 118 receives and processes the audio signal of the user.

The head motion measurement sensor 119 is installed at one side of the wearable display device 100 worn by the user to sense the head motion of the user and generate sensor data according to the degree of head motion.

The control unit 114 receives the display image and the audio signal output on the screen from the expansion reality calculation device as output information through the wireless communication interface 116.

The wearable display device 100 includes a diffuse reality calculation device that serves as a data input unit and a data output unit and is wirelessly connected to the wearable display device 100 through a communication network to calculate expansion reality content and applications.

The present invention includes the diffuse reality calculation device of the wearable display device 100 and the data calculation unit of the data input unit and the data output unit, and may be wirelessly separated from each other, and may wirelessly transmit the image signal and the audio signal between the two.

The control unit 114 applies the predetermined image expansion ratio or the image reduction ratio to the plurality of areas and pixel values in the camera image data, converts the camera image data into the same position coordinate and pixel size as the output image data, and adjusts the image size so that the camera image data, the output image data, and the audio video data have the same size.

The data exchanged between the wearable display device 100 and the diffuse reality calculation device in real time may transmit and receive high quality image and audio in real time, and may transmit and receive small amounts of serial data such as head motion information as well as large amounts of data such as high quality image.

The wireless communication interface 116 includes a communication protocol compatible with the communication network to communicate with the expansion reality calculation device through the communication network to perform data transmission and reception.

Here, the communication network refers to a connection structure capable of information exchange between respective nodes such as terminals and servers, and includes a local area network, a wide area network, the Internet, a wired/wireless data communication network, a telephone network, a wired/wireless television communication network, and the like.

Examples of the wireless data communication network include, but are not limited to 3G, 4G, 5G, 3GPP (3rd Generation Partnership Project), LTE (Long Term Evolution), WIMAX (World Interoperability for Microwave Access), Wi-Fi, Bluetooth communication, infrared communication, ultrasonic communication, VLC, LiFi, and the like.

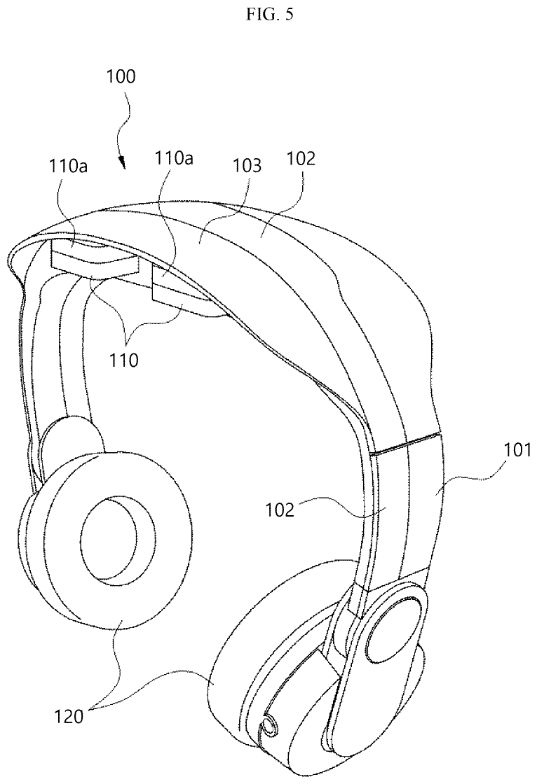

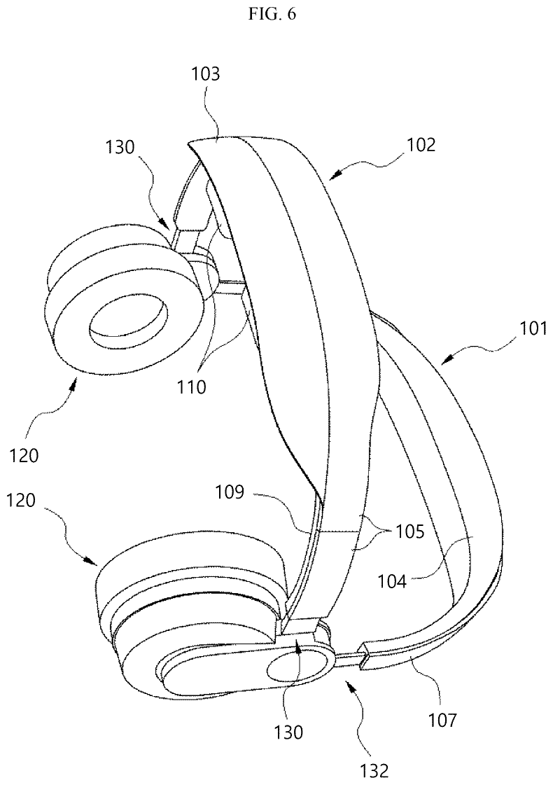

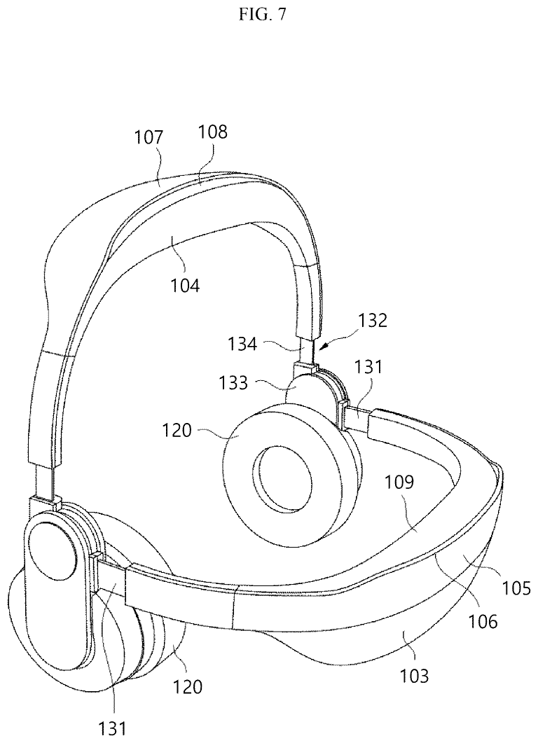

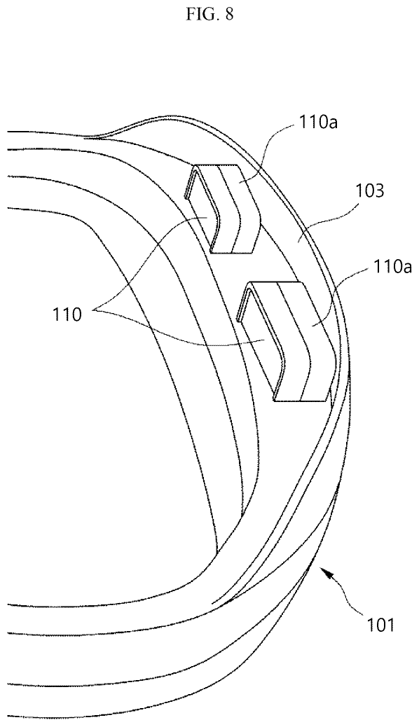

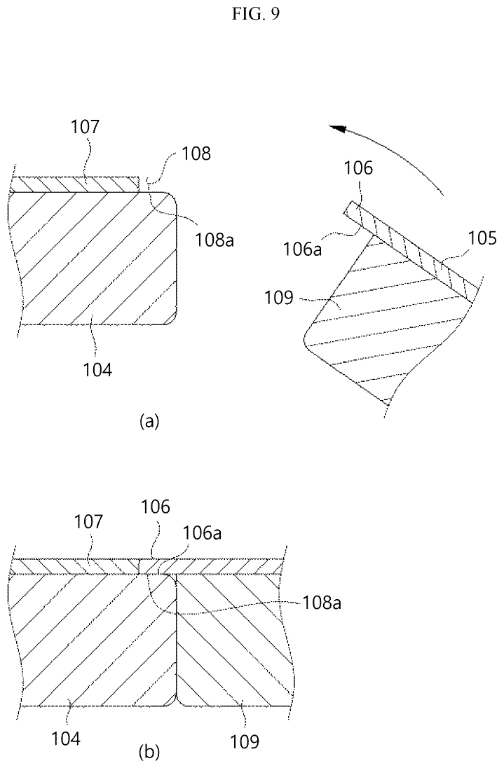

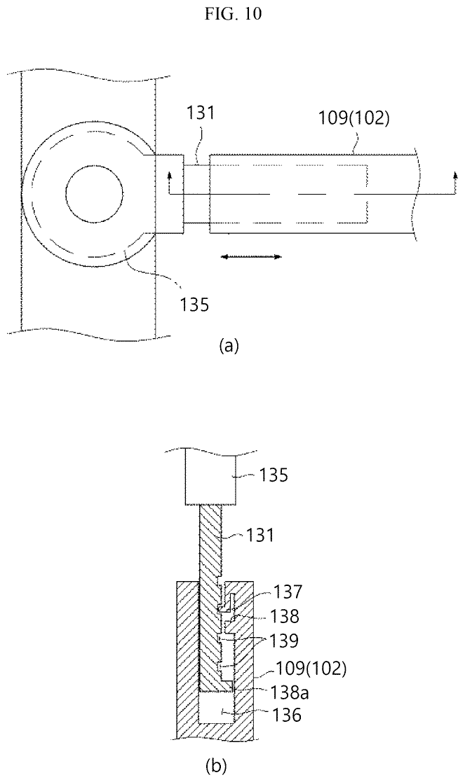

FIG. 5 is a diagram illustrating the folding state of the wearable display device according to an embodiment of the present invention, FIGS. 6 to 7 are diagrams illustrating the unfolding state of the wearable display device shown in FIG. 5, FIG. 8 is a diagram illustrating a part of the wearable display device shown in FIG. 7 by enlargement, FIG. 9 is a schematic diagram illustrating the process of moving a part of the wearable display device shown in FIG. 5 from the unfolding state to the folding state, and FIG. 10 is a diagram illustrating the length adjusting part of the wearable display device shown in FIG. 5.

The wearable display device 100 according to an embodiment of the present invention may be worn on the head of a user. The wearable display device 100 may provide augmented reality to a user (or a wearer).

The wearable display device 100 may include at least one of a seating frame 101, a rotating frame 102, a transparent display unit 110, an auxiliary transparent display unit 110a, and an ear speaker 120.

The transparent display unit 110 may include a plurality of transparent displays. The earspeaker 120 may include a plurality of earspeakers.

Seating frame 101 may be seated on the head of the user. For example, the seating frame 101 may be formed in a ‘∩’ shape open downward, and the head of the user may be fitted to the seating frame 101.

The seating frame 101 may include a seating frame body 104 that forms the shape of the seating frame 101 and a seating frame shell 107 that is disposed on an outer surface of the seating frame body 104 and forms the appearance. The seating frame shell 107 may correspond to a layer disposed on the outer surface of the seating frame body 104 with a constant thickness. The hardness of the seating frame shell 107 may be greater than the hardness of the seating frame body 104, thereby minimizing the occurrence of life defects in the seating frame 101.

The ear speaker 120 may be fixed to one end or both ends of the seating frame 101. The earspeaker 120 may output sound. The ear speaker 120 may cover the user's ear. For example, the ear speaker 120 may include a pair of ear speakers, and the pair of ear speakers 120 may be fixed to both ends (or the lower end) of the seating frame 101 to cover the pair of ears of the user, respectively.

The rotating frame 102 may be rotatably coupled to the seated frame 101. Both ends of the rotating frame 102 may be rotatably pin-coupled to the seated frame 101.

For example, the rotating frame 102 may be formed in a “∩” shape in which one side is opened to correspond to the seated frame 101, and both ends of the rotating frame 102 may be rotatably coupled to both lower ends of the seated frame 101.

The rotating frame 102 may include a rotating frame body 109 that forms the shape of the rotating frame 102 and a rotating frame shell 105 that is disposed on the outer surface of the rotating frame body 109 and forms the appearance. The rotating frame shell 105 may correspond to a layer disposed on the outer surface of the rotating frame body 109 with a certain thickness. The hardness of the rotating frame shell 105 may be greater than the hardness of the rotating frame body 109, which may minimize the occurrence of life defects in the rotating frame 102.

The transparent display unit 110 may be fixed to the rotating frame 102 (e.g., the rotating frame body 109). The transparent display unit 110 may transmit light and output an image. The transparent display unit 110 may output an image on a light scope of an external environment incident on the user's eyes through the transparent display and overlap the image. The user may simultaneously recognize the light of the external environment and the image output from the transparent display 110, and may receive augmented reality through this.

The transparent display unit 110 may have various transmittance and/or various resolutions. As the transparent display having various sizes and/or various transmittance and/or various resolution is being produced and sold, detailed descriptions of the transparent display equivalent to those of ordinary skill in the art will be omitted.

The rotating frame 102 may be rotated in the front-rear direction based on the rotation shaft of the rotating frame 102 formed at both ends of the rotating frame 102, and the transparent display unit 110 and the auxiliary transparent display unit 110a may be rotated in the front-rear direction together with the rotating frame 102. The transparent display unit 110 may be selectively positioned in front of the user's eyes by the rotation of the rotation frame 102.

Meanwhile, the state in which the rotating frame 102 is rotated to the rearward and is joined or coupled to the seated frame 101 may be referred to as a folded state, and the state in which the rotating frame 102 is rotated to the front of the user's eyes and covers the user's eyes may be referred to as an unfolded state. When in the folded state, the rotating frame 102 may be disposed on the upper part of the user's head. When in the unfolded state, the rotating frame 102 may be disposed in front of the user's eyes. When the rotating frame 102 is in an unfolded state, the transparent display unit 110 may be disposed in front of the user's eyes, and the user may recognize the image output by the transparent display unit 110. When the rotating frame 102 is in a folded state, the transparent display unit 110 may be located on the top of the user's head and removed from the front of the user's eyes, and the user may not recognize the image output by the transparent display unit 110.

Meanwhile, the seating frame 101 may further include a seating groove in which one end of the rotation frame 102 is seated or closely attached to prevent the rotation frame 102 which is rotated rearward and overlapped with the seating frame 101 from unintentionally rotating forward. In other words, the seating groove may prevent the folding frame 102 from being rotated in a direction in which the folding frame 102 is inadvertently unfolded.

For example, the seating groove 108 may be formed by cutting a predetermined front end portion of the seating frame shell 107.

The bottom surface 108a of the seated groove 108 may be formed by the upper surface of the seated frame body 104. The rotating frame 102 may further include a seating protrusion 106 inserted into the seating groove 108 and closely attached to the bottom surface 108a of the seating groove 108. The seated protrusion 106 may correspond to the upper end of the rotating frame shell 105 when it is in an unfolded state. Seating protrusions 106 may not overlap with the rotating frame body 109. In the folded state, the seating protrusion 106 may protrude toward the rear, and the lower surface 106a of the seating protrusion 106 may be in close contact with the bottom surface 108a of the seating groove 108. The rotating frame 102 may be fixed in a state of being overlapped with the seating frame 101 until an external force is applied to a certain level or more by the frictional force between the one surface 106a (e.g., the bottom surface) of the seating protrusion 106 and the bottom surface 108a of the seating groove 108.

The bottom surface 108a of the seated groove 108 may be formed substantially horizontally. However, this is not limited thereto. For example, the bottom surface 108a of the seated groove 108 may be inclined to extend in a direction in which the height from the ground is lowered as it extends from the front end to the back end of the bottom surface 108a. In this case, one surface 106a (e.g., a lower surface) of the seating protrusion 106 corresponding to the bottom surface 108a of the seating groove 108 may also be formed to be inclined to have the same inclination as the bottom surface 108a of the seating groove 108. When in the folded state, the bottom surface 108a of the seated groove 108 and the one surface 106a (e.g., the bottom surface) of the seated protrusion 106 may be parallel to each other and may be in close contact with each other. As described above, the bottom surface 108a of the seated groove 108 and the one surface 106a (e.g., the bottom surface) of the seated protrusion 106 are formed as a sloping surface facing downward as it goes to the rear, so the coupling between the seated frame 101 and the rotating frame 102 may be more firm when they are in the folded state.

The rotating frame 102 may further include a shield 103 disposed in front of the transparent display unit 110. The shield 103 may be fixed to the rotating frame body 109 and/or the rotating frame shell 105. The shield 103 may cover the transparent display unit 110 and may protect the transparent display unit 110 from external shocks. The shield 103 may be substantially transparent. The shield 103 may transmit light from an external environment. The shield 103 may transmit light (or light diameter) of an external environment to guide it to the transparent display unit 110. The transparent display unit 110 may transmit light emitted from the shield 103 to guide the user's eye and output an image to emit the image toward the user's eye.

The rotating frame 102 may include a first length adjuster 130 (or a “first length adjuster”) that connects the rotating frame body 109 and the seated frame 101 (e.g., the seated frame body 104) and adjusts the distance between the transparent display unit 110 and the user's eyes. The first length adjuster 130 may form the rotation shaft of the rotation frame 102 and adjust the length of the rotation frame 102. In the unfolding state, the first length adjuster 130 may move the rotating frame body 109 and/or the rotating frame shell 105 and/or the transparent display unit 110 and/or the shield 103 in the front-rear direction.

The first length adjusting unit 130 may include at least one of a boss 135 rotatably coupled to the seating frame 101, a band 131 extending in one direction from the boss 135 and forming a plurality of grooves 139 on one surface thereof, an insertion groove 136 formed at one end of the rotating frame body 109 to insert the band 131, an elastic protrusion 137 protruding from the inner surface of the insertion groove 136 and inserting one end into one of the plurality of grooves 139 and elastically deformed in a direction in which the one end is removed from the inserted groove 139 when a force is applied by the band 131 by a predetermined strength or more, and a stopper 138 and 138a to prevent the band 131 from being removed from the insertion groove 136.

The boss 135 may form the rotation shaft of the rotating frame 200. The plurality of grooves 139 may be formed on the inner surface of the band 131 and may be arranged to be spaced apart from each other at equal intervals along the longitudinal direction of the band 131.

An outer surface of one end of the elastic protrusion 137 inserted into the groove 139 may be formed as a curved surface. When the band 131 is pulled in a direction away from the insertion groove 136 or pushed in a direction into the insertion groove 136 with a force more than a certain intensity, the curved surface of one end of the elastic protrusion 137 and one surface (e.g., the side surface) of the groove 139 of the band 131 are in contact with each other, the force of pulling or pushing the band 131 is transferred to one end of the elastic protrusion 137, and the force of pulling or pushing the band 131 by the curved surface of one end of the elastic protrusion 137 may elastically deform the elastic protrusion 137 so that one end of the elastic protrusion 137 escapes from the groove 139. The elastic protrusion 137 missing from a certain groove 139 may meet with another groove 139 by sliding movement of the band 131, and at this time, the elastic protrusion 137 may be elastically restored and thus one end may be inserted into the other groove 139. The elastic protrusion 137 may be fixed so that the band 131 does not move until a force more than a certain intensity is applied.

The stoppers 138 and 138a may include a band-side stopper 138a formed on the other end of the band 131 opposite the end of the band 131 connected to the boss 135 and a groove-side stopper 138 protruding from the inner surface of the insertion groove 136. The band-side stopper 138a may be moved along with the band 131. The band 131 can be removed from the insertion groove 136 until the band-side stopper 138a and the groove-side stopper 138 are in contact with each other, but the band 131 can no longer be moved in the direction of being removed from the insertion groove 136 by the groove-side stopper 138 stopping the motion of the band-side stopper 138a. As such, the stoppers 138 and 138a can limit the range of movement of the rotating frame body 109 that is relatively moved with respect to the band 131.

In the unfolded state, the user can intuitively and easily adjust the focus of the transparent display unit 110 by adjusting the distance between the transparent display unit 110 and the eye using the first length adjusting unit 130.

Meanwhile, the seating frame 101 may further include a second length adjuster 132 that adjusts the length of the seating frame 101. The second length adjuster 132 may adjust the length of the seating frame 101 in the vertical direction. The user may adjust the length of the seating frame 101 according to his head using the second length adjuster 132.

The second length adjusting portion 132 may include at least one of a holder 133 disposed under the seating frame body 104 and fixing the ear speaker 120, a band 134 extending in one direction (e.g., vertical direction) from the holder 133 and forming a plurality of grooves on one surface thereof, an insertion groove (not shown) formed at one end of the seating frame body 104 to insert the band 134, an elastic protrusion (not shown) protruding from the inner surface of the insertion groove and inserting one end into one of the plurality of grooves and elastically deformed in a direction from the groove into which the one end is inserted when a force is applied by the band 134 by a predetermined strength or more, and a stopper (not shown) preventing the band 134 from escaping from the insertion groove. The rotating frame 102 may be rotatably coupled to the holder 133.

For example, the boss 135 of the first length adjuster 130 may be rotatably coupled to the holder 133.

The band 134, the insertion groove, the elastic protrusion, and the stopper of the second length adjusting portion 132 have the same or similar structure and function as the band 131, the insertion groove 136, the elastic protrusion 137, and the stoppers 138 and 138a of the first length adjusting portion 130 described with reference to FIG. 6, and thus a detailed description thereof will be omitted.

The band 131, the insertion groove 136, the elastic protrusion 137, the band side stopper 138a, and the groove side stopper 138 of the first length adjuster 130 may be referred to as the first band, the first insertion groove, the first elastic protrusion, the first band side stopper, and the first groove side stopper, respectively, and the band 134, the insertion groove, the elastic protrusion, the band side stopper, and the groove side stopper of the second length adjuster 132 may be referred to as the second band, the second insertion groove, the second elastic protrusion, the second band side stopper, and the second groove side stopper, respectively.

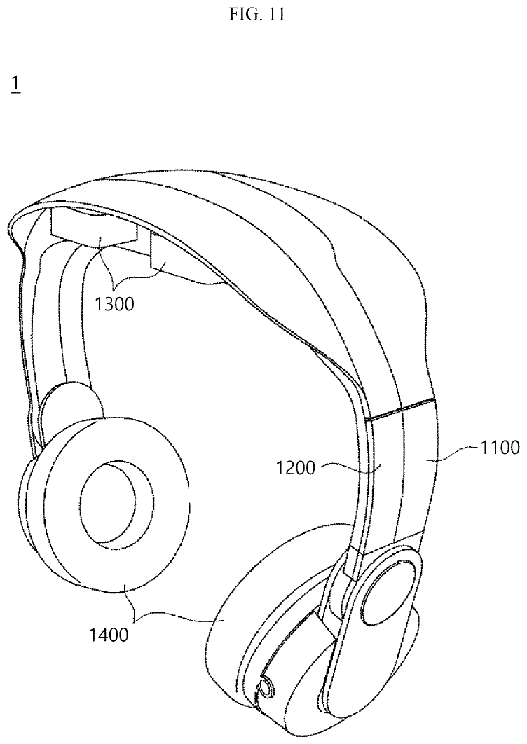

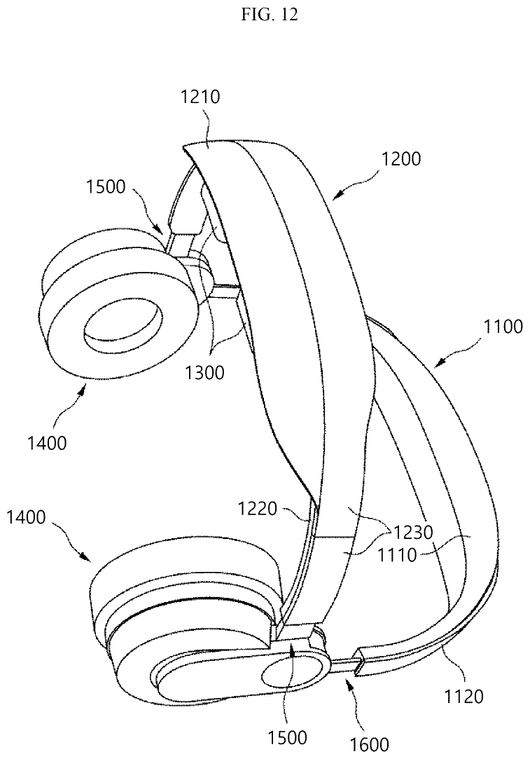

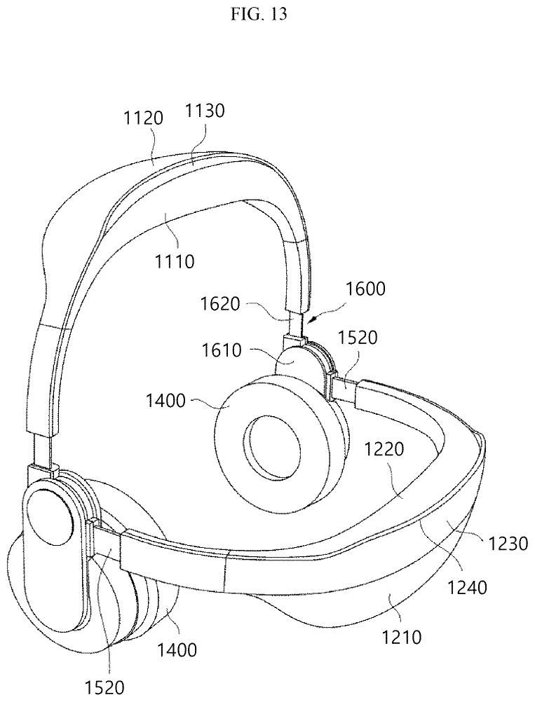

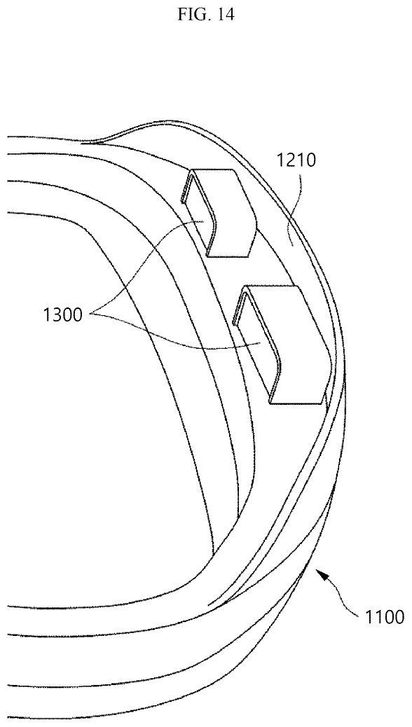

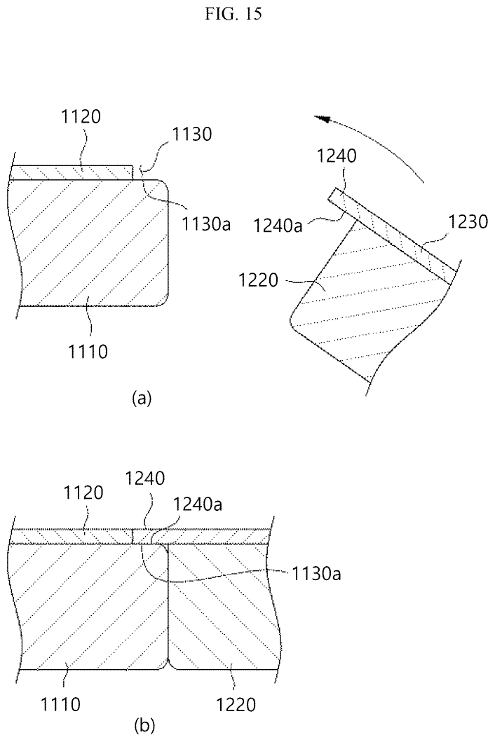

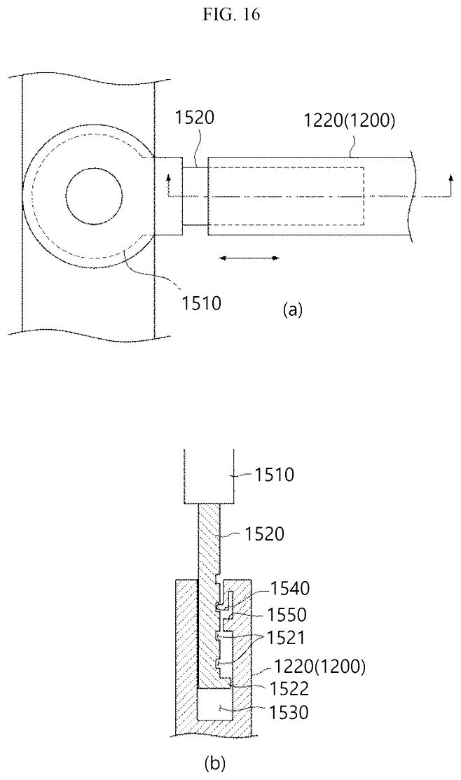

FIG. 11 is a diagram illustrating a folding state of a wearable display device according to an embodiment of the present invention. FIGS. 12 to 13 are diagrams illustrating the unfolding state of the wearable display device illustrated in FIG. 11. FIG. 14 is an enlarged view of a portion of the wearable display device illustrated in FIG. 11. FIG. 15 is a schematic diagram illustrating a process of moving a part of the wearable display device illustrated in FIG. 11 from an unfolded state to a folded state. FIG. 16 is a diagram illustrating the length adjusting part of the wearable display device illustrated in FIG. 11.

Referring to FIGS. 11 to 16, a wearable display device 1 may be worn on the head of a user. The wearable display device 1 may provide augmented reality to a user (or a wearer).

The wearable display device 1 may include at least one of the seated frame 1100, the rotating frame 1200, the transparent display 1300 (or “image output unit”), and the earspeaker 1400 (or “sound output unit”). The transparent display 1300 may include a plurality of transparent displays. The earspeaker 1400 may include a plurality of earspeakers. In the following description, all “transparent displays” may be replaced by “image output unit 1300”, and all “earspeakers” may be replaced by “sound output unit 1400”. It may be understood that a transparent display corresponds to a kind of image output unit.

The seating frame 1100 may be seated on the head of the user. For example, the seating frame 1100 may be formed in a ‘∩’ shape open downward, and the head of the user may be fitted to the seating frame 1100.

The seating frame 1100 may include a seating frame body 1110 that forms the shape of the seating frame 1100 and a seating frame shell 1120 that is disposed on an outer surface of the seating frame body 1110 and forms an appearance. The seating frame shell 1120 may correspond to a layer disposed on the outer surface of the seating frame body 1110 with a certain thickness. The hardness of the seated frame shell 1120 may be greater than the hardness of the seated frame body 1110, and thus the occurrence of life defects in the seated frame 1100 may be minimized.

The ear speaker 1400 may be fixed to one end or both ends of the seating frame 1100. The earspeaker 1400 may output sound. The ear speaker 1400 may cover the user's ear. For example, the ear speaker 1400 may include a pair of ear speakers, and the pair of ear speakers may be fixed to both ends (or the lower end) of the seating frame 1100 to cover the pair of ears of each user.

The rotating frame 1200 may be rotatably coupled to the seated frame 1100. Both ends of the rotating frame 1200 may be pin-coupled to the seated frame 1100 to be rotatable. For example, the rotating frame 1200 may be formed in a “∩” shape in which one side is opened so as to correspond to the seated frame 1100, and both ends of the rotating frame 1200 may be rotatably coupled to both lower ends of the seated frame 1100.

The rotating frame 1200 may include a rotating frame body 1220 that forms the shape of the rotating frame 1200, and a rotating frame shell 1230 that is disposed on an outer surface of the rotating frame body 1220 and forms the appearance. The rotating frame shell 1230 may correspond to a layer disposed on the outer surface of the rotating frame body 1220 with a certain thickness. The hardness of the rotating frame shell 1230 may be greater than the hardness of the rotating frame body 1220, and thus the occurrence of life defects in the rotating frame 1200 may be minimized.

The transparent display 1300 (or “image output unit”) may be fixed to the rotating frame 1200 (e.g., the rotating frame body 1220). The transparent display 1300 may transmit light and output an image. The transparent display 1300 may output an image on a light scope of an external environment incident on the user's eyes through the transparent display and overlap the image. The user may simultaneously recognize the light of the external environment and the image output from the transparent display 1300, and through this, the augmented reality may be provided. transparent

The display 1300 may have various transmittance and/or various resolutions. As the transparent display having various sizes and/or various transmittance and/or various resolution is being produced and sold, detailed descriptions of the transparent display equivalent to those of ordinary skill in the art will be omitted.

The rotating frame 1200 may be rotated in the front-rear direction based on the rotation shaft of the rotating frame 1200 formed at both ends of the rotating frame 1200, and the transparent display 1300 may be rotated in the front-rear direction together with the rotating frame 1200. The transparent display 1300 may be selectively positioned in front of the user's eyes by the rotation of the rotation frame 1200.

Meanwhile, the state in which the rotating frame 1200 is rotated to the rearward and is joined or coupled to the seating frame 1100 may be referred to as a folding state, and the state in which the rotating frame 1200 is rotated to the front of the user's eyes and covers the user's eyes may be referred to as an unfolding state. When in the folded state, the rotating frame 1200 may be disposed on the upper part of the user's head. When in the unfolded state, the rotating frame 1200 may be disposed in front of the user's eyes. When the rotating frame 1200 is unfolded, the transparent display 1300 may be disposed in front of the user's eyes, and the user may recognize the image output by the transparent display 1300. When the rotating frame 1200 is in a folded state, the transparent display 1300 may be positioned on the head of the user and removed from the front of the user's eyes, and the user may not recognize the image output by the transparent display 1300.

Meanwhile, the seating frame 1100 may further include a seating groove 1130 in which one end of the rotation frame 1200 is seated or closely attached to prevent the rotation frame 1200 rotated rearward and overlapped with the seating frame 1100 from unintentionally rotating forward. In other words, the seating groove 1130 may prevent the folding frame 1200 from being rotated in a direction in which the folding frame 1200 is inadvertently unfolded.

For example, the seating groove 1130 may be formed by cutting a predetermined front end portion of the seating frame shell 1120. The bottom surface 1130a of the seated groove 1130 may be formed by the upper surface of the seated frame body 1110. The rotating frame 200 may further include a seating protrusion 1240 inserted into the seating groove 1130 and closely attached to the bottom surface 1130a of the seating groove 1130. The seating protrusion 1240 may correspond to the upper end of the rotating frame shell 1230 when it is in an unfolded state. The seated protrusion 1240 may not overlap the rotating frame body 1220. In the folded state, the seating protrusion 1240 may protrude toward the rear, and the lower surface 1240a of the seating protrusion 1240 may be in close contact with the bottom surface 1130a of the seating groove 1130. The rotating frame 1200 may be fixed in a state of being overlapped with the seating frame 1100 until an external force of a predetermined level or more is applied by the frictional force between the one surface 1240a (e.g., the bottom surface) of the seating protrusion 1240 and the bottom surface 1130a of the seating groove 1130.

The bottom surface 1130a of the seated groove 1130 may be formed substantially horizontally. However, this is not limited thereto. For example, the bottom surface 1130a of the seated groove 1130 may be inclined to extend in a direction in which the height from the ground is lowered as it extends from the front end to the back end of the bottom surface 1130a. In this case, one surface 1240a (e.g., a lower surface) of the seating protrusion 1240 corresponding to the bottom surface 1130a of the seating groove 1130 may also be formed to be inclined to have the same inclination as the bottom surface 1130a of the seating groove 1130. In the folded state, the bottom surface 1130a of the seating groove 1130 and one surface 1240a (e.g., the bottom surface) of the seating protrusion 1240 may be parallel to each other and may be in close contact with each other. As described above, the bottom surface 1130a of the seated groove 1130 and the one surface 1240a (e.g., the bottom surface) of the seated protrusion 1240 are formed as a slope facing downward as they go backward, so the coupling between the seated frame 1100 and the rotating frame 1200 may be more firm when they are in the folded state.

The rotating frame 1200 may further include a shield 1210 disposed in front of the transparent display 1300. The shield 1210 may be fixed to the rotating frame body 1220 and/or the rotating frame shell 1230. The shield 1210 may cover the transparent display 1300 and may protect the transparent display 1300 from an external shock. The shield 1210 may be substantially transparent. The shield 1210 may transmit light from an external environment. The shield 1210 may transmit light (or light diameter) of the external environment to guide it to the transparent display 1300. The transparent display 1300 may transmit light emitted from the shield 1210 to guide the user's eye and output an image to emit the image toward the user's eye.

The rotating frame 1200 may include a length adjuster 1500 (or “first length adjuster”) that connects the rotating frame body 1220 and the seated frame 1100 (e.g., the seated frame body 1110), and adjusts the distance between the transparent display 1300 and the user's eyes. The first length adjusting unit 1500 may form the rotation shaft of the rotation frame 1200 and adjust the length of the rotation frame 1200. In the unfolded state, the first length adjuster 1500 may move the rotating frame body 1220 and/or the rotating frame shell 1230 and/or the transparent display 1300 and/or the shield 1210 in the front-rear direction.

The first length adjuster 1500 may include at least one of a boss 1510 rotatably coupled to the seating frame 1100, a band 1520 extending in one direction from the boss 1510 and forming a plurality of grooves 1521 on one surface thereof, an insertion groove 1530 formed at one end of the rotating frame body 1220 to insert the band 1520, an elastic protrusion 1540 protruding from the inner surface of the insertion groove 1530 and inserting one end into one of the plurality of grooves 1521, and elastically deformed in a direction from the groove 1521 into which the one end is inserted when a force is applied by the band 1520 by a predetermined strength or more, and a stopper 1550, 1522 preventing the band 1520 from escaping from the insertion groove 1530.

The boss 1510 may form a rotation shaft of the rotating frame 1200. The plurality of grooves 1521 may be formed on the inner surface of the band 1520 and may be arranged to be spaced apart from each other at equal intervals along the length direction of the band 1520.

An outer surface of one end of the elastic protrusion 1540 inserted into the groove 1521 may be formed as a curved surface. When the band 1520 is pulled in a direction away from the insertion groove 1530 or pushed in a direction into the insertion groove 1530 with a force more than a certain intensity, the curved surface of one end of the elastic protrusion 1540 and one surface (e.g., the side surface) of the groove 1521 of the band 1520 are in contact with each other, the force of pulling or pushing the band 1520 is transferred to one end of the elastic protrusion 1540, and the force of pulling or pushing the band 1520 by the curved surface of one end of the elastic protrusion 1540 may elastically deform the elastic protrusion 1540 so that one end of the elastic protrusion 1540 escapes from the groove 1521. The elastic protrusion 1540 from a certain groove 1521 may meet with another groove 1521 by the sliding movement of the band 1520, and at this time, the elastic protrusion 1540 may be elastically restored and thus one end may be inserted into the other groove 1521. The elastic protrusion 1540 may be fixed so that the band 1520 does not move until a force more than a certain intensity is applied.

The stoppers 1550 and 1522 may include a band-side stopper 1522 formed on the other end of the band 1520, which is opposite to the one end of the band 1520 connected to the boss 1510, and a groove-side stopper 1550 protruding from the inner surface of the insertion groove 1530. The band-side stopper 1522 may be moved along with the band 1520. When the band-side stopper 1522 and the groove-side stopper 1550 are in contact with each other, the band 1520 may be removed from the insertion groove 1530, but the band 1520 may no longer be moved from the insertion groove 1530 by allowing the groove-side stopper 1550 to stop the movement of the band-side stopper 1522. As such, the stoppers 1550 and 1522 may limit the range of movement of the rotating frame body 1220 that is relatively moved relative to the band 1520.

In the unfolded state, the user can intuitively and easily adjust the focus of the transparent display 1300 by adjusting the distance between the transparent display 1300 and the eye using the first length adjusting unit 1500.

Meanwhile, the seating frame 1100 may further include a second length adjuster 1600 that adjusts the length of the seating frame 1100. The second length adjuster 1600 may adjust the length of the seating frame 1100 in the vertical direction. The user may adjust the length of the seating frame 1100 according to his head using the second length adjuster 1600.

The second length adjuster 1600 may include at least one of a holder 1610 disposed under the seating frame body 1110 and fixing the ear speaker 1400, a band 1620 extending in one direction (e.g., vertical direction) from the holder 1610 and forming a plurality of grooves on one surface thereof, an insertion groove (not shown) formed at one end of the seating frame body 1110 so that the band 1620 is inserted, an elastic protrusion (not shown) protruding from the inner surface of the insertion groove and inserting one end into one of the plurality of grooves and elastically deformed in a direction in which the one end is removed from the inserted groove when a force more than a predetermined strength is applied via the band 1620, and a stopper (not shown) preventing the band 1620 from being removed from the insertion groove.

The rotating frame 1200 may be rotatably coupled to the holder 1610. For example, the boss 1510 of the first length adjuster 1500 may be rotatably coupled to the holder 1610.

The band 1620, the insertion groove, the elastic protrusion, and the stopper of the second length adjuster 1600 have the same or similar structure and function as the band 1520, the insertion groove 1530, the elastic protrusion 1540, and the stopper 1550 and 1522 of the first length adjuster 1500 described with reference to FIG. 6 and thus a detailed description thereof will be omitted.

The band 1520, the insertion groove 1530, the elastic protrusion 1540, the band side stopper 1522, and the groove side stopper 1550 of the first length adjuster 1500 may be referred to as the first band, the first insertion groove, the first elastic protrusion, the first band side stopper, and the first groove side stopper, respectively, and the band 1620, the insertion groove, the elastic protrusion, the band side stopper, and the groove side stopper of the second length adjuster 1600 may be referred to as the second band, the second insertion groove, the second elastic protrusion, the second band side stopper, and the second groove side stopper, respectively.

However, the operations according to the embodiments of the present specification are not limited to the above embodiments, and the operations according to the embodiments of the present specification are read by a computer.

It is possible to embody a computer-readable program or code on a computer-readable recording medium. The computer-readable recording medium includes all kinds of recording devices in which data readable by a computer system is stored. In addition, the computer-readable recording medium may be distributed in a computer system connected by a network, and a computer-readable program or code may be stored and executed in a distributed manner.

When the embodiment is implemented in software, the above-described techniques may be implemented as modules (process, function, and the like) that perform the above-described functions. The module may be stored in the memory and executed by the processor. The memory may be inside or outside the processor, and may be connected to the processor by various well-known means.

In addition, the computer-readable recording medium may include a hardware device specially configured to store and perform program instructions, such as a ROM, a RAM, a flash memory, and the like. The program instructions may include not only machine language codes such as those made by a compiler, but also higher-level language codes that can be executed by a computer using an interpreter.

Although some aspects of the present invention have been described in the context of the device, they may also represent the description according to the corresponding method, and in this case, the block or device corresponds to the method step or the feature of the method step. Similarly, aspects described in the context of the method may also be represented by the corresponding block or item or the feature of the corresponding device. Some or all of the method steps may be performed (or used) by a hardware device such as, for example, a microprocessor, a programmable computer, or an electronic circuit. In some embodiments, one or more of the most important method steps may be performed by such a device.

In embodiments, a programmable logic device (e.g., a field programmable gate array) may be used to perform some or all of the functions of the methods described herein. In embodiments, the field programmable gate array may operate together with a microprocessor for performing one of the methods described herein. In general, the methods are preferably performed by any hardware device.

Although the above description has been made with reference to the preferred embodiments of the present invention, it will be understood by those skilled in the art that the present invention may be modified and changed in various ways without departing from the spirit and scope of the present invention as set forth in the appended claims.

### DESCRIPTION OF REFERENCE NUMBER

100: wearable display device
110: transparent display unit
110a: auxiliary transparent display unit
111: camera unit
112: image signal controller
113: video encoder
114: control unit
115: video decoder
116: wireless communication interface unit
117: audio output unit
118: microphone input unit
119: head motion measurement sensor unit
119a: image information storage unit
1: wearable display device
1100: seating frame
1200: rotating frame
1300: transparent display
1400: earspeaker
1500: first length adjustment unit
1600: second length adjustment unit

1. A wearable display device for virtual object visibility, the wearable display device comprising:
A transparent display unit that displays virtual objects on image of actual objects in a real space; and
An auxiliary transparent display unit that generates a shaded area corresponding to the virtual objects behind the virtual objects; and
wherein shaded area prevents an image of the actual objects from passing through the virtual objects, so that the virtual objects do not appear superimposed on the actual objects in the real space.

2. The wearable display device for virtual object visibility according to claim 1,
wherein the transparent display unit and the auxiliary transparent display unit form a structure that protrudes toward user on the same glass band.

3. The virtual object visibility wearable display device of claim 1,
wherein the transparent display unit and the auxiliary transparent display unit are separately formed to distinguish between left and right eyes.

4. The virtual object visibility wearable display device of claim 1,
wherein the transparent display unit and the auxiliary transparent display unit form a stacked structure on the glass band.

5. The virtual object visibility wearable display device of claim 1,
further comprising a control unit that controls the shadow area to be output to the auxiliary transparent display unit when the virtual object is displayed on the transparent display unit.

6. The virtual object visibility wearable display device of claim 5,
wherein the control unit separates foreground pixels and background pixels from the virtual object to perform binarization processing, generates contours from the binarized virtual object to calculate the size and position of the shaded area, and adjusts each pixel value of the calculated shaded area to perform shading.

7. The virtual object visibility wearable display device of claim 6,
wherein the control unit determines the foreground pixel and the background pixel by converting an input image into a predetermined size, calculating a covariance of color values (r, g, b) of each pixel, and separating them into k Gaussian distributions.

8. The virtual object visibility wearable display device of claim 5,
wherein the control unit performs a scale adjustment operation by matching a total pixel location and size of the transparent display unit and the auxiliary transparent display unit, calculates a location and pixel size of the virtual object information in the transparent display unit, and calculates a location and pixel size of the shadow area in the auxiliary transparent display unit based on the calculated location and the pixel size of the virtual object information.

9. The virtual object visibility wearable display device of claim 5,
wherein the control unit synchronizes and simultaneously outputs a display of the virtual object on the transparent display unit and a display of the shadow area on the auxiliary transparent display unit.

10. The virtual object visibility wearable display device of claim 5,
wherein the control unit converts a camera image data to have a same position coordinate and a pixel size as an output image data and adjusts an image size so that the camera image data and the output image data have the same size.

11. A wearable display device worn on a user's head and providing augmented reality, the wearable display device comprising: a seating frame seated on the user's head;
a rotating frame rotatably coupled to the seating frame;
an image output unit fixed to the rotating frame and transmitting light of an external environment and outputting an image; and
a sound output unit fixed to one end of the seating frame to cover the user's ears and outputting sound,
wherein the image output unit is selectively disposed in front of the user's eyes as the image output unit is rotated together with the rotating frame.

12. The virtual object visibility wearable display device of claim 1, wherein the rotating frame comprises:
a rotating frame body forming a shape of the rotating frame and being fixed the image output unit; and
a length adjusting unit configured to connect the rotating frame body and the seating frame and to adjust a distance between the image output unit and the user's eyes.

13. The virtual object visibility wearable display device of claim 2, wherein the rotating frame is located in front of the image output unit and further comprises a shield configured to transmit light of an external environment to guide the light to the image output unit.
